(19) United States
(12) Patent Application Publication
(10) Pub. No.: US 2003/0152216 A1
(43) Pub. Date: Aug. 14, 2003

(54) Acoustic enhancement of frequencies with large amplitude variation in an active noise cancellation system

(76) Inventor: Manish Vaishya, Auburn Hills, MI (US)

Correspondence Address: SIEMENS CORPORATION, INTELLECTUAL PROPERTY LAW DEPARTMENT, 170 WOOD AVENUE SOUTH, ISELIN, NJ, 08830, US

(21) Appl. No.: 10/339,539

(22) Filed: Jan. 9, 2003

Related U.S. Application Data
(60) Provisional application No. 60/348,482, filed on Jan. 14, 2002.

(51) Int. Cl. H04M 9/08

(52) U.S. Cl. 379/406.01

(57) ABSTRACT

An active noise attenuation system includes a speaker, and a microphone. The microphone detects a combination of sound from the speaker and noise in the system. The resulting noise is compared with a reference signal. The reference signal is a desired signal for the system. The combination of the reference signal and the desired signal results in a correction signal. The system of this invention includes first and second reference signal generation paths. A first path generates a signal according to a multiplier and a digital model the system. The second path generates an absolute sound pressure level according to engine rpm. The absolute sound pressure level provides a reference signal for shaping sound at orders of inconsistent or undetectable engine sound. The system selects or combines reference signals from each signal generation path to cover all engine sound orders

This application claims priority to U.S. Provisional Application No. 60/348,482, which was filed on Jan. 14, 2002.

### BACKGROUND OF THE INVENTION

This invention generally relates to active noise cancellation systems and more particularly to generating a reference signal based on an absolute sound pressure level for specific engine orders.

Noise cancellation systems are currently used on automotive vehicles for reducing noise propagation into the passenger compartment. Vehicles equipped with an air induction system often experience an undesirable side affect of engine noise emanating from the air intake of such a magnitude as to be noticeable within a passenger compartment. Various efforts have been made to reduce the amount of engine noise traveling through the air induction system. Some arrangements include using passive devices such as expansion chambers and Helmholtz resonators. Other efforts include active methods such as anti-noise generators.

Typical active systems include a speaker that generates a sound to attenuate the noise. The sound from the speaker typically is out of phase with the noise and combines with the noise such that the result is a reduced or enhanced sound, which results in less noise transmission into the passenger compartment, for example. The speaker sound can be referred to as a noise cancellation signal.

In such active systems, a reference signal is compared to the resulting sound emanating from the intake. The sound is a combination of the raw engine noise, and the cancellation signal. In many cases, the resulting sound is not precisely what is desired and a correction is made. A correction signal or error signal is used to adjust the cancellation signal to achieve the desired sound from the engine. However, in some instances the sound at orders of low engine noise do not provide a sufficiently consistent or detectable signal for generation of an error signal. In such instances, system stability problems are often encountered. Further, the inability to detect many different engine sound orders with a single microphone is problematic. As appreciated, a single microphone is optimized to encompass most of the engine sound orders, potentially leaving some engine sound in undetectable or inconsistent detection ranges.

Accordingly, it is desirable to develop a system for providing a correction signal at inherently low and undetectable raw engine noise levels to allow improved attenuation and enhancement of engine noise.

### SUMMARY OF THE INVENTION

An embodiment of this invention is a method and system for canceling noise that includes using an absolute sound pressure level of specified weak engine orders for comparison to actual sound output at an error microphone.

A system designed according to this invention includes a speaker, and a microphone arranged to detect a combination of a sound from the speaker and noise in the system. The speaker is driven to emit a cancellation signal in response to a signal from a tone generator. The tone generator generates the signal according to engine parameters monitored by a sensor. The cancellation signal emitted from the speaker combines with the system noise. The microphone detects the combination and compares the actual sound to a reference signal indicative of a desired sound.

The reference signal is generated by first and second signal generation paths. One of the signal generation paths generates a reference signal according to a digital model of the physical system (i.e., speaker, microphone, etc . . . ). A second reference signal is generated according to an absolute sound pressure level desired for a specific engine order or rpm. The absolute sound pressure level is generated according to specific engine operating parameters such as rpm. At low engine noise levels, the absolute sound pressure level is not susceptible to inherent variation and detection problems. The reference signal from each of the reference signal generation paths are selected according to application specific parameters to accommodate orders at which the raw engine noise is undetectable.

Accordingly, the active noise system includes a second reference signal generation path for generating a reference signal according to a desired absolute sound pressure level for shaping sound at orders of inherently low engine noise.

### BRIEF DESCRIPTION OF THE DRAWINGS

The various features and advantages of this invention will become apparent to those skilled in the art from the following detailed description of the currently preferred embodiments. The drawings that accompany the detailed description can be briefly described as follows.

FIG. 1 schematically illustrates selected portions of an active noise cancellation system designed according to this invention.

FIG. 2 schematically illustrates an alternative arrangement to the embodiment of FIG. 1.

FIG. 3 graphically illustrates cancellation of specific engine noise according to an embodiment of this invention;

FIG. 4 graphically illustrates enhancement of engine noise according to an embodiment of this invention; and

FIG. 5 graphically illustrates the effects of absolute sound pressure level according to an embodiment of this invention.

### DETAILED DESCRIPTION OF THE PREFERRED EMBODIMENTS

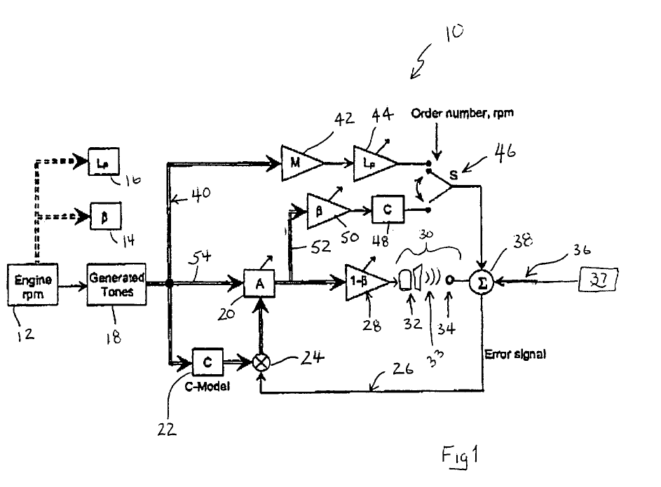

FIG. 1 schematically shows selected portions of an active noise cancellation system 10. This system 10 may have a variety of uses where active noise cancellation is desired. For purposes of discussion, the system 10 will be assumed part of an active noise cancellation system for canceling noise in an air induction system on a vehicle that is useful for reducing the level of engine noise that propagates into a passenger compartment. The invention is not limited to such an environment.

A tone generator 18 generates a reference signal responsive to information from a sensor 12. In the illustrated example, the sensor 12 comprises a tachometer that provides information regarding the rotations per minute (RPM) of a vehicle engine. The tone generator 18 preferably includes programming to provide a plurality of discrete tones each having a known frequency, which tones are selected based upon the information regarding the engine RPM. The particular frequencies and the number of tones generated by the tone generator 18 preferably are selected to meet the needs of a particular situation. Those skilled in the art that have the benefit of this description can use known techniques for deciding how the tone generator 18 should respond to the different inputs available from the sensor 12.

A cancellation signal generating module 20 modifies the reference signal tones from the tone generator 12 and provides a cancellation signal to a multiplier module 28. The multiplier module 28 modifies the signal from the signal-generating module 20 by applying a multiplier β 14. The multiplier β 14 is applied to the signal that modifies the signal forwarded to the speaker 32 according to the specific order. Preferably, β 14 is a function of engine rpm in order for the sound quality to be regulated for the entire engine operating range. β 14 values of zero value signify that all sound at that engine order should be canceled. A β 14 value of 1.0 signifies no change of sound at that engine order. Further, a β 14 value above 1 signifies a level of modification or enhancement of the sound from the engine. The resulting signal modified by the multiplier module 28 drives a speaker 32. A noise cancellation signal (i.e., sound) 33 emanates from the speaker 32 responding to the signal generated from the module 20 modified by the multiplier module 28.

The noise cancellation signal 33 attenuates or enhances noise within the system to a desired level. A microphone 34 provides modeling and feedback information regarding the results of the noise cancellation signal 33. The microphone 34 detects the combination of noise within the system and the noise cancellation signal 33. Noise emanating from the system is schematically shown at 36 and in this example originates from an air intake for an air induction system, schematically shown at 37. Under ideal circumstances, the noise cancellation signal 33 has the effect of minimizing the noise to a desired level.

The signals from the microphone 34 preferably are processed, using a summer 38 for example, to determine whether the desired noise cancellation effect is achieved. The desired level of noise cancellation in the illustrated example is provided to the summer 38 by a first and second desired signal generation path 52, 40. The results of the comparison between the desired signal from one of the desired signal generation paths 52, 40 and the information received by the microphone 32 provide an error signal 26 that is input to a convergence module 24. The illustrated example utilizes any one of a variety of known convergence techniques so that repeated modifications to the noise cancellation signal eventually result in the desired noise reduction in the system.

A model module 22 (i.e., the C-model) provides a digital model of the physical system in order to modify the reference signal 54 from the tone generator 18. This allows continuous modification of the reference signal information using the convergence module 24 to repeatedly update the effects of a cancellation signal generated by the module 20 so that an ideal cancellation signal for a given input may be determined. Those skilled in the art that have the benefit of this description will realize that a variety of convergence techniques may be used as known to accomplish the results needed for this portion of a noise cancellation system designed according to this invention.

The model module 22 preferably operates based upon a frequency domain response of the physical path of the system 10 that includes the speaker 32 and the microphone 34 (i.e., the so-called secondary path generally indicated at 30).

The first reference generating path 52 includes a modeling module 48. The modeling module 48 modifies a signal from a multiplier module 50. The multiplier module 50 receives a signal from the signal-generating module 20. The first reference-generating path 52 receives the signal from the signal-generating module 20 and applies the multiplier β 14 based on specific engine rpm. A signal emerging from the multiplier 50 acts as desired tones for the system 10 and is subsequently followed by a C-model of the modeling module 48. The modeling module 48 modifies the desired tones according to changes that may occur in the secondary path 30 because of environmental conditions or changes in the system as is known to occur during operation.

In some instances, sound characteristics of certain engine order are weak or there is a very low sound pressure level at a specific rpm. Such circumstances result in low signals available for detection. Further, background noise at other frequencies or from other sources can cause a weak signal or sound pressure level. The low sound pressure level makes detection of specific engine orders difficult and therefore attenuation and enhancement difficult and unpredictable.

The system of this invention includes the second reference signal-generating path 40 that utilizes a signal based on an absolute sound pressure level for each engine rpm. A required sound pressure level constitutes a desired signal that is fed to the summer 38. The tones are generated from the crank position or engine rpm so that the frequency is synchronized and are amplified by multiplier module 44 according to the required sound pressure level Lp 16. The tones are summated and fed to the summer 38. In addition to the presence of an external desired signal, this approach does not require filtering through a digital model of the secondary path 30 and does not required modification by a multiplier block according to β 14 for values not equal to one. The second reference signal-generating path 40 is used for inherently weak engine orders.

The second reference generating path 40 includes a microphone calibration module 42. The method requires additional knowledge of microphone sensitivity. The frequency response of the microphone 34 can be assumed constant over specific frequency ranges. The magnitude of response of the microphone 34 has been determined to vary only slightly. The slight variation in microphone response is compensated for using computed frequency and a known response function. A signal from the tone generator 18 is modified to account for microphone response at specific frequencies. The signal is then forwarded through the multiplier module 44 for amplification according to the generated sound pressure level Lp16. The signal is then sent to the summer 38 for comparison with the cancellation signal 33.

According to an example of implementation of this invention schematically illustrated at FIG. 1, the tone generator 18 generates a signal based on information from a sensor 12 indicative of engine rpm. The absolute sound pressure level Lp 16 and a multiplier β 14 are generated according to the engine rpm. The signal from the tone generator 18 is forwarded to the cancellation signal generating module 20 and is modified according an error signal 26 that input from the convergence module 24, and also in view of the digital model of the secondary path 30 within the model module 22. The resulting cancellation signal is forwarded to the multiplier module 28 and modified according to β 14 and converted to a signal to drive the speaker 32. The noise cancellation signal 33 is detected by the microphone 34 and forwarded to the summer 38 along with a desired signal. The signal from the microphone 43 is compared to the desired signal to provide the error signal 26. The desired signal is provided by one of the first and second reference signal generation paths 52, and 40.

In one embodiment, the two reference signal generation paths 52, 40 are mutually exclusive and are selected according to specific engine orders. A switch 46 selectively engages one of the reference generating paths according to the specific order. The first reference-generating path 52 is selected for engine orders that generate a sufficient sound characteristic to allow proper application of the multiplier β 14. The second signal generation path 52 is selected for inherently weak orders that are difficult to detect. The specific engine is either sensed according to the sensor 12 or are predetermined and programmed in a known controller that actuates the switch 44.

In another embodiment, the switch 44 is actuated in response to both engine order and sensed engine rpm. The use of both engine order and rpm allows for the filling of holes in any order range, and the multiplier β can be used to retain the engine sound characteristics at other segment of rpm.

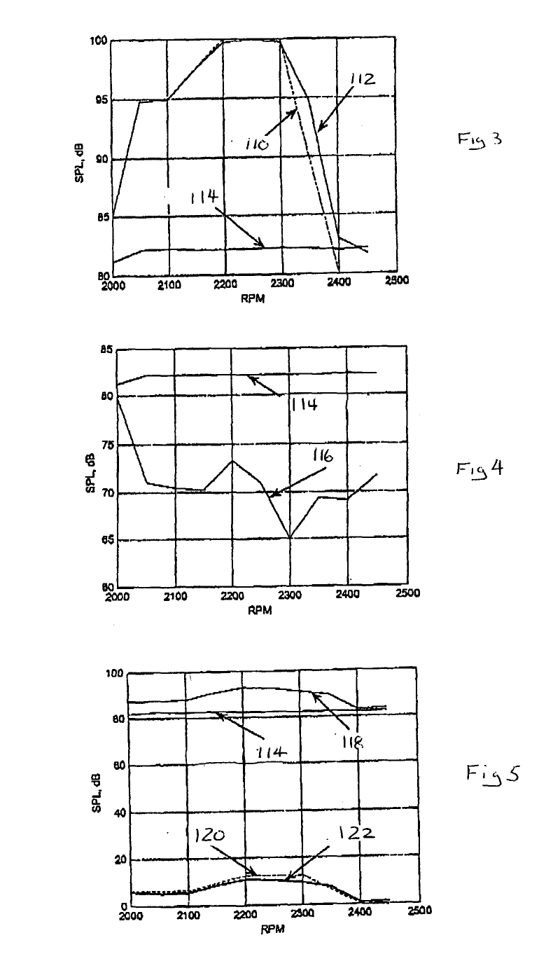

Referring to FIG. 3, another system designed according to this invention is generally indicated at 60 and includes an additional summer 104 to combine reference signals generated from first and second reference signal generation paths 78, 76. In the system 60, modifier blocks 106 and 108 are included in respective reference signal generation paths 78, 76 and filter reference signals to the summer 104 according an algorithm based in response to engine order and rpm. The first and second reference signal generation paths 78, 76 act simultaneously to provide attenuation and enhancement for complex applications. The reference signals generated by the first and second paths 78, 76 are distributed and added to combine into a signal desired single forwarded to the summer 92 and compared to the cancellation signal received from the microphone 88. A signal 90 is also summed at the summer 92 and is indicative of noise emanating from an air induction system schematically shown at 91.

In operation, a tone generator 68 generates tones according to readings from a sensor 62 indicative of engine rpm. An absolute sound pressure level Lp 66, and a multiplier β 64 are generated according to engine rpm. The signal from the tone generator is sent to a cancellation signal-generating module 70 and is modified according to an error signal 82 input from a convergence module 80, and in view of a model module 72 a digital model of the secondary path 94.

The resulting cancellation signal is forwarded to the multiplier module 84 and modified according to β 66 and converted to a signal to drive the speaker 86. The noise cancellation signal 87 is detected by the microphone 88 along with induction noise 90, and forwarded to the summer 92. The summer combines the detected cancellation signals 87 and induction noises 90 with the desired signal from the summer 104. The signal from the microphone 88 is compared to the desired signal to provide the error signal 82.

The desired signal is provided by a combination of the first and second reference signal generation paths 78, 76. The first reference signal-generating path 78 includes a modeling module 98 and a multiplier module 96. A signal emerging from the multiplier 96 is filtered through the modeling module 98 to a second multiplier module 108. The second multiplier module 108 changes the reference signal according to specific engine orders and engine rpm. The multiplier module 108 acts to filter the reference signal in order to combine with signals from the second reference signal-generating path 76 at the summer 104.

The second reference-generating path 76 includes a microphone calibration module 100 and a multiplier module 102 for amplification according to the generated sound pressure level Lp66. The signal is then sent to the multiplier 106 for modification according to specific engine order and engine rpm.

The combination of reference singles from the first and second reference signal generating paths 76, 78 is based on specific application sensitive parameters. The signals from each signal generating path is combined to provide desired noise attenuation and enhancement and operates to improve system performance. An algorithm as is known to a worker skilled in the art can be used to combine the generated reference signal from each reference signal generating path to accomplish desired application specific noise attenuation and enhancement.

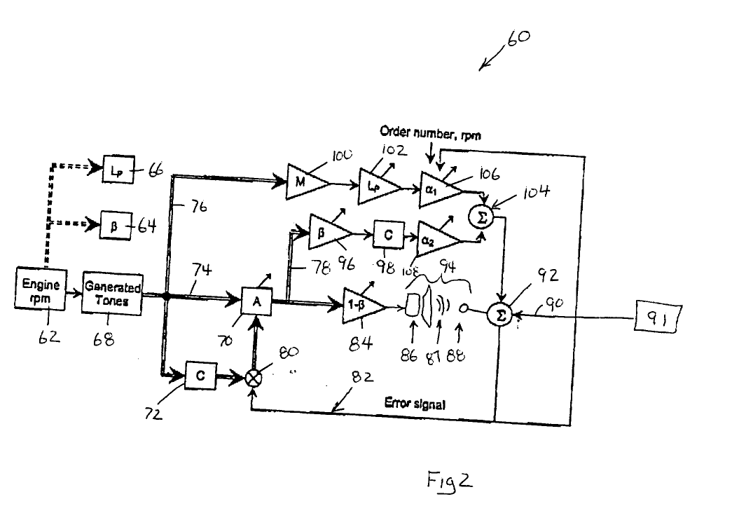

The various modules discussed above and schematically illustrated in FIGS. 1 and 2 comprise software within a controller in some example systems designed according to this invention. The various modules may not necessarily require distinct or separate portions of software code to achieve the results accomplished by each of the modules. The module distinctions within this description are schematic and for illustration purposes only as those skilled in the art may realize that there are functions of one or more of the modules that may be accomplished within another module designed according to this invention. Additionally, while software modules are utilized in one preferred implementation of this invention, various microprocessors or dedicated portions of controllers may be used to perform the same functions. Additionally, custom designed circuitry may accomplish one or more of the functions of the modules described in this specification. Those skilled in the art that have the benefit of this description will be able to decide what combination of software and hardware will work best to meet the needs of their particular situation. Given this description, those skilled in the art will be able to develop the necessary software code to achieve the results provided by this invention.

This invention provides an improved system by providing an absolute sound pressure level reference signal for inherently weak engine orders. The use of absolute sound pressure level to produce a reference signal eliminates inconsistencies and variations caused by the difficulties in detecting sounds at the weak engine orders.

FIGS. 3-5 graphically illustrate digital simulations at different engine orders and cancellation or enhancement of engine sound. Referring to FIG. 3, a 12 engine order is shown with a desired full cancellation. The target sound pressure level 110 is shown relative to active noise control level 112 and engine noise level 114.

FIG. 4 graphically illustrates 3^{rd} order raw engine noise and the accompanying output noise 116 with the active noise cancellation according to this invention. FIG. 5 graphically illustrates raw engine noise 114 and an enhanced sound output with the active noise control system according to this invention indicated at 118. A target sound pressure level is shown for a very low raw engine noise order at 120 and the targeted change using the method and system of this invention as indicated at 122.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

I claim:

1. A method of generating a reference signal in a noise cancellation system comprising the steps of:
selecting between a first reference signal generation path and a second reference signal generation path in response to a sensed condition;
comparing a reference signal generated according to said selected reference generation path with a signal indicative of induction noise and speaker output; and
generating an error signal based on said comparison of said generated reference signal with said signals indicative of induction noise and speaker output.

2. The method of claim 1, including generating a reference signal according to a signal multiplier in said first reference signal generation path.

3. The method of claim 2, including modifying said reference signal according to a digital model of the system in said first reference signal generation path.

4. The method of claim 2, including generating a value for said signal multiplier according to said sensed condition.

5. The method of claim 1, including generating said reference single according to an absolute sound pressure level within said second reference single generation path.

6. The method of claim 5, including modifying said sound pressure level according to a microphone calibration factor.

7. The method of claim 5, wherein said predetermined sound pressure level corresponds to a specified engine rpm.

8. The method of claim 1, including selecting one of said first and second reference signal generation paths according to a specific engine rpm.

9. The method of claim 1, including selecting one of said first and second reference signal generation paths in response to a predetermined sound order.

10. The method of claim 1, including combining said error signal with a digital model of said system for modifying generated tones to powering a sound cancellation speaker.

11. The method of claim 1, including generating a tone according to a sensed condition indicative of a specific engine parameter and emitting a cancellation signal to modify a portion of noise emitted from an air induction system.

12. A method of generating a reference signal in a noise cancellation system comprising the steps of:
generating a speaker drive signal in response to a sensed condition;
actuating a speaker according to said speaker drive signal with said signal to modify a noise emanating from an air induction system;
combining reference signals generated from first and second reference signal generation paths into a general reference signal;
comparing said general reference signal with signals indicative of noise from said air induction system and from said speaker; and
generating an error signal based on said comparison of said general reference signal and said signal indicative of induction noise and speaker output.

13. The method of claim 12, including modifying said speaker drive signal in view of said error signal to continuously update noise emitted from said speaker.

14. The method of claim 12, including generating said reference signal in said first signal generation path generate according to a signal multiplier and a digital model of a portion of said system.

15. The method of claim 12, including generating a reference signal within said second reference single generation path according to a sound pressure level, and generating said sound pressure level according to said sensed condition.

16. The method of claim 15, including modifying said sound pressure level according to a microphone calibration factor.

17. The method of claim 12, wherein said sensed condition corresponds to a signal indicative of a specified engine rpm.
